(19) United States
(12) Patent Application Publication
(10) Pub. No.: US 2004/0203516 A1
(43) Pub. Date: Oct. 14, 2004

(54) Mobile phone

(76) Inventors: Tiao-Hsing Tsai, Taipei (TW); Kuo-Hsiang Wu, Taipei (TW)

Correspondence Address: BIRCH STEWART KOLASCH & BIRCH, PO BOX 747, FALLS CHURCH, VA, 22040-0747, US

(21) Appl. No.: 10/284,379

(22) Filed: Oct. 31, 2002

(30) Foreign Application Priority Data
May 9, 2002 (TW) 091206605

(51) Int. Cl. H04B 1/38

(52) U.S. Cl. 455/90.3; 455/550.1; 455/575.1

(57) ABSTRACT

A mobile phone comprising at least a phone body and an antenna is disclosed. The antenna is coupled to the phone body in a detachable manner, and the phone body further includes a circuit board. The antenna is joined with the circuit board in a manner of tenon joint or connecting, so that the electricity is connected. The antenna includes a single band, a dual band or a multi-band antenna.

This application incorporates by reference of Taiwan application Serial No. 091206605, filed May 9, 2002.

### BACKGROUND OF THE INVENTION

1. Field of the Invention

The invention relates in general to a mobile phone, and more particularly to a mobile phone including a detachable antenna.

2. Description of the Related Art

Along with the rapid growth in the industry of electronic products and advance in technology, new communication products are constantly brought forth and marketed. In recent years, portable electronic products, the mobile phone for example, which cover a versatile range of functions, have become a necessity to the public in their everyday life. Mobile phones of various manufacturers nowadays have very little differences in terms of functions. How to design a mobile phone with a better communication quality has thus become an important feature in attracting the consumers.

Referring to FIG. 1, a circuit board of a conventional mobile phone is shown. The circuit board 100 includes at least a main function circuit 110 and an antenna 120. The circuit board 100 implements all functions of a mobile phone except transmitting and receiving the signals, while an antenna 120 provides the function of transmitting and receiving the wireless signals. Generally, the antenna 120 is fixed to the circuit board 100. Most of the mobile phones at present are of the dual band or tri-band, in other words, the frequencies of the antenna 120 are mostly dual band or tri-band. Since the adjustment of the dual band or tri-band frequency of the antenna is not easy, the communication quality of each mobile phone is quite different. And thus the communication qualities in different areas are very possible to be inconsistent, so as to impact the consumer rights.

Accordingly, the drawbacks of the conventional mobile phones are as followings. First, the communication quality of each mobile phone is inconsistent. Due to the difficulty to tune the frequency of the dual band or tri-band antennas, the communication quality of each mobile phone is rather different, and thus it has a bad effect on the consumer rights. Second, an aim to improve the communication quality cannot be implemented. The dual band or tri-band antennas are fixed to the circuit board. In other words, the communication quality of each mobile phone has been determined as soon as released. Therefore it is impossible to make any improvement of the low communication quality after use.

### SUMMARY OF THE INVENTION

It is therefore an object of the invention to provide a mobile phone that the communication quality of each band for the mobile phone can be consistent. Another object of the invention is to provide a mobile phone that the communication quality of each mobile phone can be improved.

Accordingly, the objects of the invention are achieved by a mobile phone construction, which is characterized as follows. The mobile phone comprises at least a phone body and an antenna. The antenna is coupled to the phone body in a detachable manner, and the phone body further includes a circuit board. The antenna is joined with the circuit board in a manner of tenon joint or connecting, so that the electricity is connected. The antenna includes a single frequency, a dual band frequency or a multi-band frequency antenna.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (prior art) shows a circuit board of a conventional mobile phone.

FIG. 2 shows a construction of a mobile phone according to the preferred embodiment of the present invention.

FIG. 3 shows a tenon joint construction of an antenna and a circuit board according to a preferred embodiment of the present invention.

FIG. 4 shows a connecting construction of an antenna and a circuit board according to a preferred embodiment of the present invention.

### DETAILED DESCRIPTION OF THE INVENTION

The present invention provides a mobile phone and focuses on the modular design of the antennas. Each antenna module can be tuned to the optimal condition and also the antenna of best efficiency can be replaced to meet different requirement in different areas, so as to obtain the best communication quality everywhere every time. Generally, the conventional mobile phone includes dual band or tri-band antenna. Since it is not easy to adjust the dual band or tri-band antenna, the communication quality of each band of the mobile phone is inconsistent. Furthermore, the antenna of the conventional mobile phone is fixed to the circuit board, so the antenna cannot be substituted to achieve a better communication performance. Consequently, the invention highlights on the modular design of the antenna that ensures each antenna module to achieve the best performance and obtain the optimal communication quality in every area.

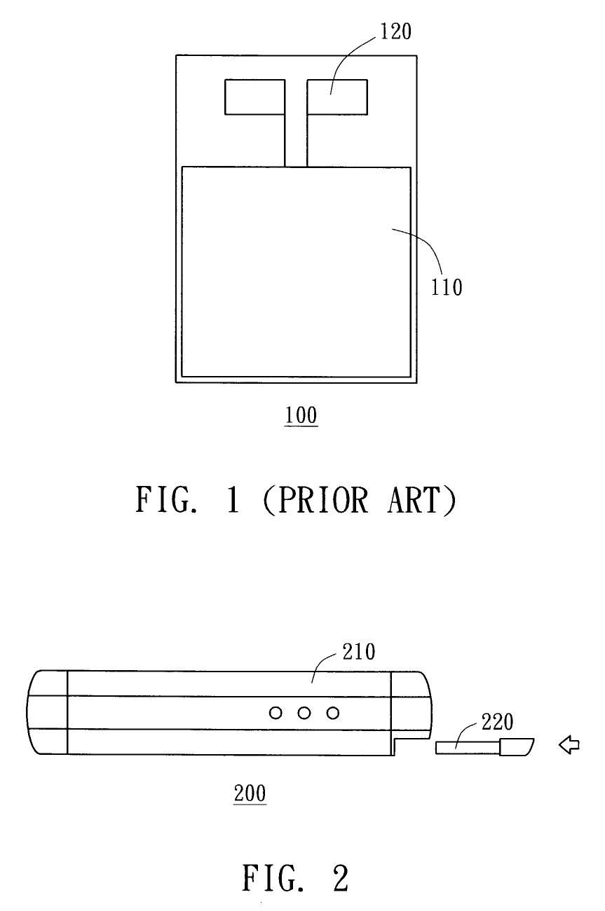

Referring to FIG. 2, a construction of a mobile phone according to the preferred embodiment of the present invention is shown. The mobile phone 200 includes at least a housing 210 and an antenna 220. The antenna 220 is coupled to the housing 210 in a manner that can be disassembled. For instance, the single band antenna, like 900,1800 or 1900 MHz, which is easier to be tuned, or the dual band antenna, like 900/1800, 900/1900, or 1800/1900 MHz, or the tri-band antenna of 900/1800/1900 MHz, etc. Significantly, the single frequency antennas with different working frequencies mentioned above can be tuned to the optimal condition. In spite the dual band and tri-band antennas are not easy to be tuned to the optimum, it is not against the spirit of the invention, which lies on the premise of the modular design of the antennas. When using a single frequency mobile phone, the most suitable single frequency of the antenna module can be chosen in that area to achieve the optimal communication quality. As to use the mobile phone with dual band or tri-band frequency antenna modules, the communication quality is not as good as the single frequency antenna module; however, it is not against the spirit of the invention that the antenna modules are detachable and can be substituted.

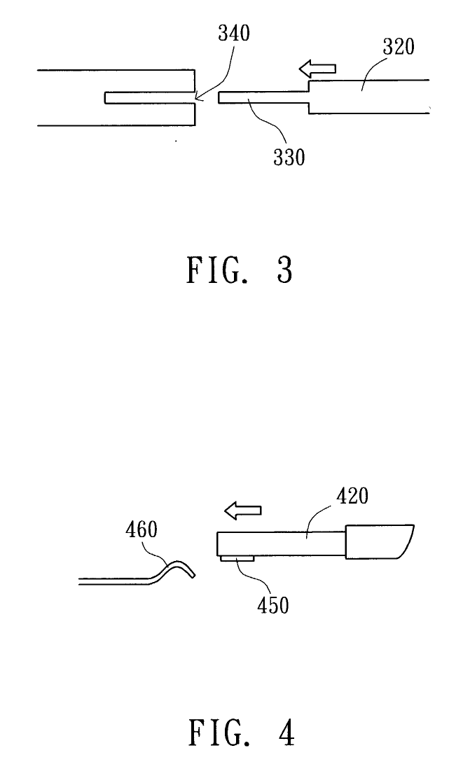

Referring to FIG. 3, a tenon joint construction of an antenna and a circuit board according to the preferred embodiment of the present invention is shown. A tenon 330 of the antenna 320 is joined with a mortice lock 340 of the circuit board, following the direction of the arrow shown in the drawing, so that the antenna 320 is fixed to the circuit board and the antenna 320 and the circuit board are electrically coupled. On the contrary, the antenna 320 can be detached from the circuit board and taken apart from the mobile phone body following the opposite direction of the arrow.

Referring to FIG. 4, a connecting construction of an antenna and a circuit board according to the preferred embodiment of the present invention is shown. As the antenna 420 moves along the direction of the arrow, the contact point 450 can contact with a metal clip 460 of the circuit board so that the antenna 420 and the circuit board can be electrically coupled. The metal clip 460 is elastic, and provides the function of electrically coupling the antenna 420 and the circuit board and also of enabling the antenna 420 to attach to the circuit. Similarly, the antenna 420 can be detached from the circuit board and taken apart from the mobile phone body following the opposite direction of the arrow.

Accordingly, the advantages of the present invention include at least as follows. First, the communication quality of different band of the mobile phone is consistent. In virtue of the optimal state of each antenna module being tuned, the communication quality of each band is consistent, so as to protect the consumer rights. Second, the bad communication quality can be improved. Since the antenna module is detachable, the best suitable module in different areas can be chosen to obtain the best communication quality everywhere anytime.

Particularly, the geometry structures of all elements are only one example of the present invention.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mobile phone, comprising:
a phone body; and
an antenna, which is coupled to the phone body in a detachable manner.

2. The mobile phone as claimed in claim 1, wherein the phone body further comprises a circuit board, and the antenna is electrically coupled to the circuit board in a mortise-tenon manner.

3. The mobile phone as claimed in claim 1, wherein the phone body further comprises a circuit board, and the antenna is electrically coupled to the circuit board by clipping.

4. The mobile phone as claimed in claim 1, wherein the antenna is a single band antenna.

5. The mobile phone as claimed in claim 1, wherein the antenna is a dual band antenna.

6. The mobile phone as claimed in claim 1, wherein the antenna is a multi-band antenna.

7. A mobile phone, comprising a phone body and an antenna, which is characterized by that the antenna is detachable from the phone body.

8. The mobile phone as claimed in claim 7, which is characterized by that the phone body further comprises a circuit board, and the antenna is electrically coupled to the circuit board in a mortise-tenon manner.

9. The mobile phone as claimed in claim 7, which is characterized by that the phone body further comprises a circuit board, and the antenna is electrically coupled to the circuit board by clipping.

10. The mobile phone as claimed in claim 7, which is characterized by that the antenna is a single band antenna.

11. The mobile phone as claimed in claim 7, which is characterized by that the antenna is a dual band antenna.

12. The mobile phone as claimed in claim 7, which is characterized by that the antenna is a multi band antenna.
